(19) United States
(12) Patent Application Publication
(10) Pub. No.: US 2008/0223636 A1
(43) Pub. Date: Sep. 18, 2008

(54) Method and device for self-contained inertial

(76) Inventor: Gottfried J. Gutsche, Mississauga (CA)

Correspondence Address: Gottfried J. Gutsche, 6816 Estoril Rd., Mississauga, ON, L5N 1N1, CA

(21) Appl. No.: 12/082,981

(22) Filed: Apr. 16, 2008

Related U.S. Application Data
(63) Continuation-in-part of application No. 11/544,722, filed on Nov. 29, 2006.

(51) Int. Cl. B60K 6/10

(52) U.S. Cl. 180/65.2

(57) ABSTRACT

A novel method and device for self-contained inertial vehicular propulsion using the combined effort of linear and rotational inertial reluctance contained in flywheels. The flywheels are having parallel axial orientation, opposite rotation and opposite alternate cyclic linear reciprocal motion in the direction of vehicular travel. The cyclic reciprocal linear motion of the flywheels have equal peak velocities with differential magnitude of linear accelerations. The differential magnitude of the linear accelerations of the flywheels is the source of linear kinetic propulsion energy. The linear inertial reluctance of the flywheels is used as the propulsion motivating impact momentum by separation and the rotational inertial reluctance of the flywheels is used as dynamic propulsion backrest. Kinetic energy is supplied to each flywheel with integral motor-generators contained within the flywheels and an attached rotational-to-reciprocating transmission is directing kinetic energy into the device in the direction of vehicular travel. The alternating induction and depletion of motivation kinetic energy into the flywheels is reaction-less and causes the differential magnitude of accelerations due to the concurrent and progressive depletion to zero distribution of the induced kinetic energy using a negative feedback loop. The negative feedback loop is accomplished with the formulation of the rotational-to-reciprocating transmission.

This is a Continuation-in-part (C.I.P) specification for original APPL Ser. No. 11/544,722

### FIELD OF THE INVENTION

The present invention relates to a device and method for developing a self-contained propulsion force in a predetermined direction, using the combined effort of rotational and linear inertia of flywheels. The use of power-strokes for every half cycle of the device delivers a high degree of thrust yield. Alternating flow of kinetic energy to the motor-generators delivers a high degree of efficiency. Electro-mechanical damping elements recycle the alternating flow of kinetic energy.

### BACKGROUND OF THE INVENTION

The earliest example of using the combined effort of rotational and linear kinetic energy to produce a large linear force is the medieval catapult called “Tre'Bucher”. The action of this catapult was so effective because of the combined effort of linear and rotational kinetic energy. Other devices relevant to the operation of the invention are the impact wrench, where accumulation of rotational kinetic energy is released in a short time to produce a large rotational impact. And a further device of relevance is the YoYo, where kinetic energy is flowing from potential kinetic energy to rotational kinetic energy. The mechanical arrangements of the before mentioned devices, including the present invention, all work with the principle of exponential growth of kinetic energy potential of a moving mass, in comparison to the magnitude of growth in velocity. Previous known patents describing self contained inertial propulsion devices using linear moving flywheels or other inertia elements are: U.S. Pat. No. 3,492,881 from Auweele, U.S. Pat. No. 3,863,510 from Benson, U.S. Pat. No. 4,242,918 from Srogi, U.S. Pat. No. 4,712,439 from North, U.S. Pat. No. 5,890,400 from Oades, U.S. Pat. No. 6,966,9987 from Laul. Aus. Pat. No. AT408649B from Gruebel. Jap. Pat. No. 7156899 from Tetsuo. and Germ. Pat. No. DE3512677 from Urmolt. The before mentioned devices, while each an important contribution in the art of inertial propulsion, develop comparatively low energy propulsion forces or high degree of vibration compared to the energy input and size of the machines. The before mentioned devices also lack directional control. The listed patents do not use kinetic energy flow in both directions of linear flywheel movement. The listed devices lack the use of logic timed alternating energy flow of motor-generators to generate an unimpeded reciprocal motor-generator to flywheel torque in an advantageous force vector projection. In addition, the use of flywheels with integral motor-generators combined with central-shaft mounted rotational-to-reciprocating transmission means is also a new development in the field. None of the patents use the advantage of timed damping means and the opposing alternating linear movement of pairs of flywheels, which has the advantage of neutralising vibrations caused by the moving masses and allows for a more continuous form of propulsion energy. A further improvement to the prior art is the use of motor-generators and damping means drivers connected to logic interfaces which maximises their operation with precision.

### BRIEF SUMMARY OF THE INVENTION

It is the objective of the present invention to provide a self contained inertial propulsion device with directional control.

It is another objective of the invention to provide an inertial propulsion device with a high degree of efficiency.

It is still another objective of the invention to provide an inertial propulsion device with a low vibration characteristic.

It is a further objective of the invention to use advanced motor controls, graphical analysis methods for complex optimisation and engineering tasks for the advancement of inertial vehicular propulsion.

Other features and advantages will be apparent from the following description with accompanying drawings.

### DESCRIPTION OF THE DRAWINGS

FIG. 1 is the top view of the mechanical representation of the propulsion device. The format is in wire-frame format for unimpeded logical perusal.

FIG. 2 is the side view of the propulsion device with the supporting frame cut open.

FIG. 3 is the top view of the propulsion device with a continuous running drive motor, external to the flywheel assemblies.

FIG. 4 is the side view of the propulsion device including a timing wheel means and timing motor.

FIG. 5 is the graphical representation of the motor-generator means drive pulses generated by the method of timing of the logic control means for continuous rotating motor-generator means.

FIG. 6 is the graphical representation of the motor-generator means drive pulses for an alternating rotation of the motor-generator means.

FIG. 7 is the graphical representation of the resultant propulsion forces when energy absorbent damping is applied under the method of logic control.

FIG. 8 is the graphical representation of the force vector flows.

FIG. 9 is the front and Top view of a further example of a propulsion drive including a complementary cam for a rotational-to-reciprocating transmission means, cam switch means and mechanical break-shoe means.

FIGS. 10,11,12 and 13 illustrates the energy, velocity and motion characteristic of the propulsion drive employing a complementary cam with the objective of providing a method of selecting component dimensions.

FIG. 14, 15 depicts the underlying mathematical principle for the device component dimension selection method and for on board display velocity data.

FIG. 16 illustrates the Design Method for a perfect dimensional combined effort Inertia Drive.

FIG. 17 depicts a combined effort inertia drive using a voice coil and motor-generator as a rotational-reciprocating transmission means.

### DETAILED DESCRIPTION OF THE PREFERRED EMBODIMENT

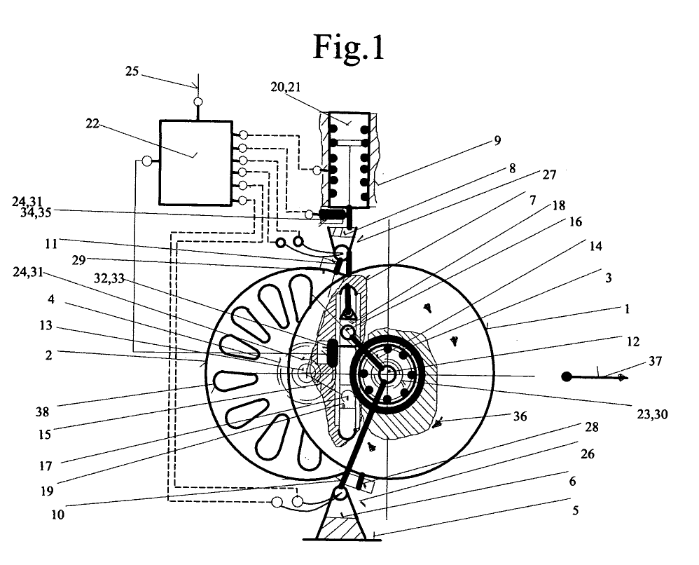

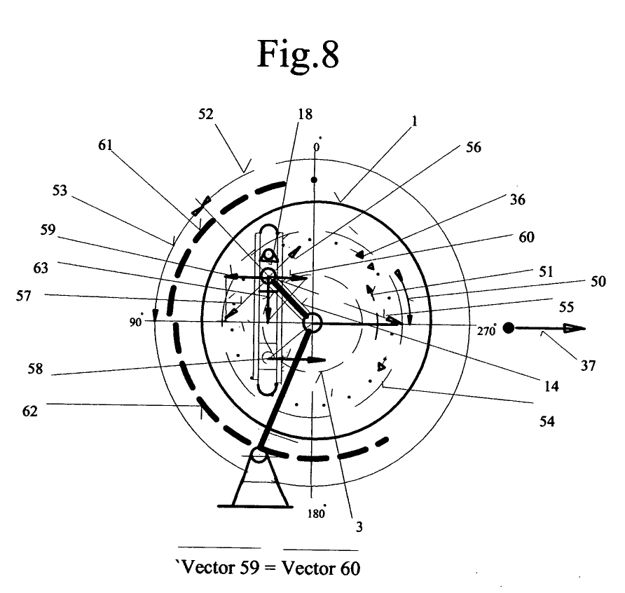

Referring to FIG. 1. The self-contained propulsion device comprising pairs of flywheels, 1 and 2, with parallel axial orientation, opposite direction of rotation and opposite alternating linear movement. The alternating linear reciprocal motion of the flywheels has a stroke length and equal peak velocities and differential accelerations for the purpose of the inertial propulsion. The Flywheels have a rotational and linear kinetic energy storage capacity for providing a dynamic inertial reluctance backrest for the propulsion of the device. Opposite alternating linear movement of the pair of flywheels accomplishes a smoothing of propulsion forces. The device can also operate with the pairs of flywheels moving in simultaneous alternating linear motion or only one flywheel, which propels the device more in individual strokes and induces a rotational momentum. The opposite direction of rotation of the inertia elements accomplishes the cancelation of rotational forces, which prevents the turning of the device around its axis. The turning action, however, is used to steer the device by varying the rotational parameters of the flywheel drives. The pair of flywheels 1 and 2, each contain integral motor-generator rotor means 3 and 4, thereby forming integral flywheel assemblies. The motor-generator rotor means has a temporary rotational kinetic energy storage capacity for the purpose of delivering a rotational impact momentum for the reaction less propulsion of the device. The motor-generator means have the capacity to convert supplied energy into rotational kinetic energy and convert rotational kinetic energy back into energy of the supplied type. The supplied type of energy can be electrical power, pneumatic power or kinetic power. These motor-generator means can be of different types of technologies, for example, a pneumatic vane motor-pump or a hydraulic gear motor-pump. For illustration, an electrical motor-generator armature with the current carrying conductors and field magnets is shown. The side-wall of the flywheel 1, is cut open to reveal the motor-generator means within the flywheel. The motor-generator means supplies alternating kinetic energy pulses to and from the flywheel assemblies, and to and from the motor-generator rotor means, causing the flywheel rotation and the flywheels progressively changing alternating linear movement. The progressively changing linear movement in combination with the flywheel mass moment of inertia is the source of dynamic back-rest for the unimpeded exertion of the kinetic propulsion energy, which is fully explained in FIG. 5, 6,7,8,10,11,12, 13,14,15,16. The supporting frame 5, of the propulsion device is also cut away from the attachment point 6,7,8 and 9 for unimpeded view of the active working elements. The propulsion device further comprises two guidance means 10 and 11, which give each flywheel assembly substantial linear freedom of movement in direction of vehicular travel. For the present embodiment, swing-arms 10 and 11 are depicted, but many other linear motion technologies are suitable to guide the flywheels in linear motion. The swing-arms contain flywheels 1 and 2 on the moveable wrist-end and pivot at the socket-end 6 and 8. The flywheels 1 and 2 rotate around the central shaft 12 and 13, by means of a first set of rotational bearings 23, while the integral motor-generator rotor means is firmly mounted co-centrically on each central shafts 12 and 13. Each central shaft is contained on the wrist-end of the swing-arms by means of a second set of rotational bearings 30. The propulsion device further comprises pairs of rotational-to-reciprocating transmission means, which includes the ex-centric members 14 and 15, which are firmly mounted on each central shaft ex-centrically in relation to the flywheel assemblies. The rotational-to-reciprocating transmission means further includes the wrist-pins 16 and 17, which are firmly mounted on the opposite end of the ex-centric members. The linear bearings 18 and 19 contain the wrist pin and also connect to the damping means 20, 21. The central shaft mounted ex-centric members 14 and 15, represent the rotational input means, as well as the reciprocating output means of the rotational-to-reciprocating transmission means. The rotational-to-reciprocating transmission means gives the flywheels an alternating opposing movement and is therefore a rotational/reciprocating input/output means. The kinetic energy output means of the rotational-to-reciprocating transmission means is represented by the wrist-pin contained in the linear baring 18 and 19. The linear bearing 18 and 19, are mounted on the supporting frame 5, perpendicular to the flywheels axis and central to the guidance means. The linear bearings 18 and 19 are allowing the wrist pins 16 and 17 freedom of linear motion. The kinetic energy output means of the rotational-to-reciprocating transmission means acts against the vehicle through the linear bearings 18 and 19, which represents the entrance point of propulsion energy into the vehicle. A further improvement to the ex-centric member is the variation of the length of the ex-centric members 14 and 15. The ex-centric member mounted with a wrist-pin contained in a linear bearing is shown in FIG. 1 which essentially represents a scotch joke mechanism. Many other transmission technologies can be adapted with similar progressive changing slope characteristics as previously described, for example: a clutch to rack and pinion type transmission, a cam operated transmissions or hydraulic transmission or a generator coupled to an voice coil. The progressive changing slope characteristic of the rotational-to-reciprocating transmission means, which allows for the alternating flow of rotational kinetic energy available in the motor generator rotor means to flow into the linear kinetic energy of the flywheel assembly and reciprocal into the device. The progressive changing slope characteristic of the rotational-reciprocating transmission is essential and central to the operation of the device and makes the device consistent with the conservation of kinetic energy, the conservation of momentum and the potential kinetic energy of moving masses law of physics. The propulsion device further comprises a power-supply, logic control means and display console means 22, which contains the logic control means that times and maximises the efficiency of the working components. For the simplest form of the device, power commutators 23 and 24 mounted respectively, to central shafts 12 and 13, and are able to supply timed power drive pulses to the motor-generator means. The logic control means has a command and control input 25 for speed and directional control of the vehicle and a display console to display working functions of the device. The method of directional control is accomplished with the differential variation of the duration and angle parameters of the motor-generator drive pulses. Power commutator 26 and control commutator 27, supply power and control information to the flywheel assemblies. The rotational position and angular speed of the flywheels 1 and 2, are sensed with the encoders 28 and 29. The rotational position and angular speed of the motor-generator means is sensed with encoders 30 and 31. The drive pressure exerted by the linear bearings 18 and 19, is sensed with pressure sensors 32 and 33. The position and linear speed of the damping means 20 and 21, is sensed with sensors 34 and 35. The damping means dampens and assists the movement of the flywheel assemblies under control of the logic control means. The directional arrow 36, indicates the continuous rotational direction of the flywheels, which is indicated in clockwise direction but can be in counter-clockwise direction, which then reverses all other directions including the propulsion direction. The directional arrow 37, indicates direction of vehicular travel. The imbedded electromagnetic poles 38, imbedded in the sidewalls of the flywheel 1 and 2, are used for absorbing excess rotational and linear kinetic energy from flywheels 1 and 2. The action of the imbedded electromagnetic poles 38, acting reciprocally between flywheels 1 and 2, has no negative influence on the propulsion force and returns excess kinetic energy of the flywheels 1 and 2, back to the power-supply 22.

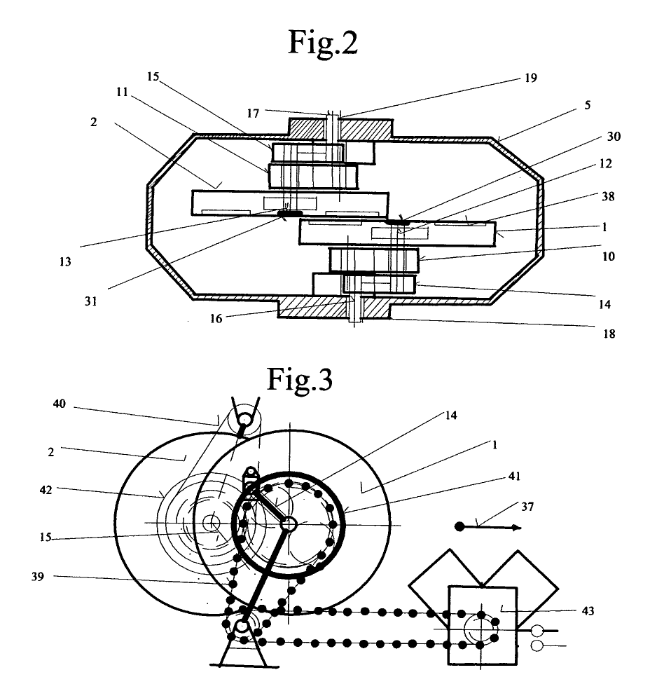

Referring to FIG. 2, which depicts the side view of the propulsion device with the supporting frame 5 cut open. The cut view of the propulsion device reveals the flywheels 1 and 2, the guidance means 10 and 11, the central shafts 12 and 13, and the motor-generator means encoders 30 and 31. The propulsion device depicted in FIG. 2 also shows the members of the variable rotational-to-reciprocating transmission means, which includes the wrist-pins 16,17, which are mounted on the ex-centric members 14 and 15 and the linear bearings 18 and 19. FIG. 2 further indicates the imbedded electromagnetic poles 38, which are imbedded in flywheels 1 and 2.

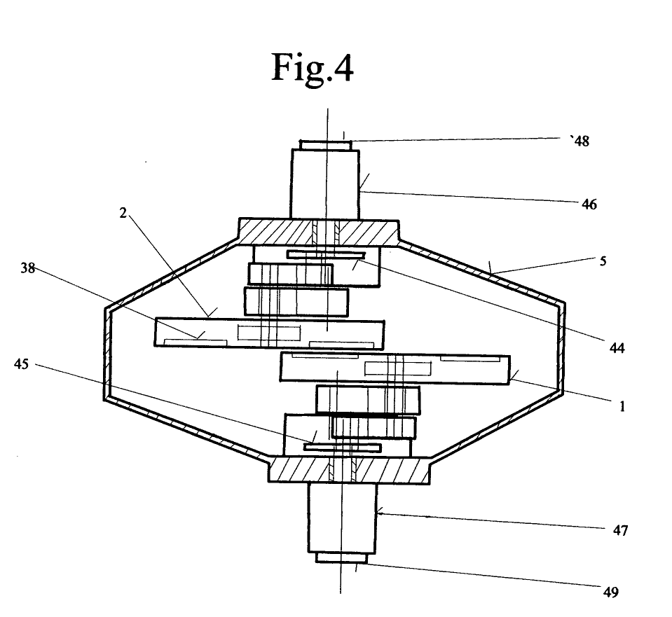

Referring to FIG. 3, which depicts the top view of the propulsion device with the rotational transmission means 39 and 40, for supplying rotational kinetic energy to the flywheels 1 and 2. The differential transmission means 41,42, distributes the rotational kinetic energy reciprocally into the ex-centric members 14,15, and into the flywheels 1 and 2. The timing, clutch and buffer means 43, times and buffers the rotational kinetic energy flow to the flywheels 1 and 2. This arrangement allows for the use of a continuous running drive motor, typically an internal combustion motor.

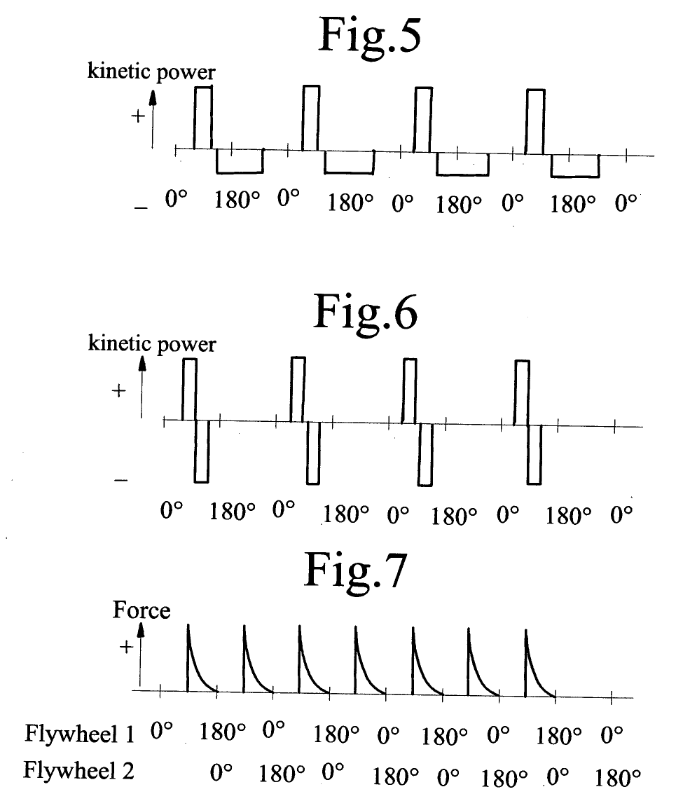

Referring now to FIG. 4, which represents the propulsion device with timing wheel means 44 and 45, for a kinetic output means of the rotational-to-reciprocating transmission means. The timing wheel means is mounted on the timing motors 46 and 47. The timing motors are mounted on the supporting frame 5, perpendicular to the flywheel assemblies axis and central to the guidance means. The timing wheel means have the purpose of timing and assisting the alternating motion of the flywheel assemblies, according to the logic control means. The timing motor shaft has an encoder or power commutator 48 and 49, attached for the purpose of timing the motor-generator energy pulses.

Referring now to FIG. 5, which depicts the graph of the motor-generator means alternating energy drive pulses, for the continuous rotation mode of the motor-generator 3 in FIG. 1. The graph depicts the drive pulses for the motor-generator rotor means. The motor-generator rotor means drive pulses start between 20-90 arc degrees, for positive drive, which drives and accelerates the flywheel 1, in the clockwise direction and drives the motor-generator rotor 3, in the counter-clockwise direction. During this angular acceleration, rotational kinetic energy is accumulated in the motor-generator rotor means 3 and 4, which is called accumulation phase. The drive phase, which is physical driving the device, is accomplished by the angular de-acceleration of flywheels 1 and 2, and the accompanying de-acceleration of the motor-generator rotor means 3 and 4, which occurs between 90-270 arc degrees, which accelerates the linear inertia of the flywheels assemblies opposite of vehicular travel. The drive phase represents a impulse by separation, driving the vehicle forward. The drive-phase effectively converts the rotational kinetic energy of the motor-generator rotor into linear kinetic energy of the vehicle. The drive phase also restores the unused kinetic energy, which was in excess of the peak linear velocity of the flywheel assembly, back into the power-supply. The drive phase kinetic drive pulse has a negative direction and has a lower intensity because kinetic energy was delivered into the device and kinetic energy must remain in the motor-generator rotor means 3, to complete the rotational cycle.

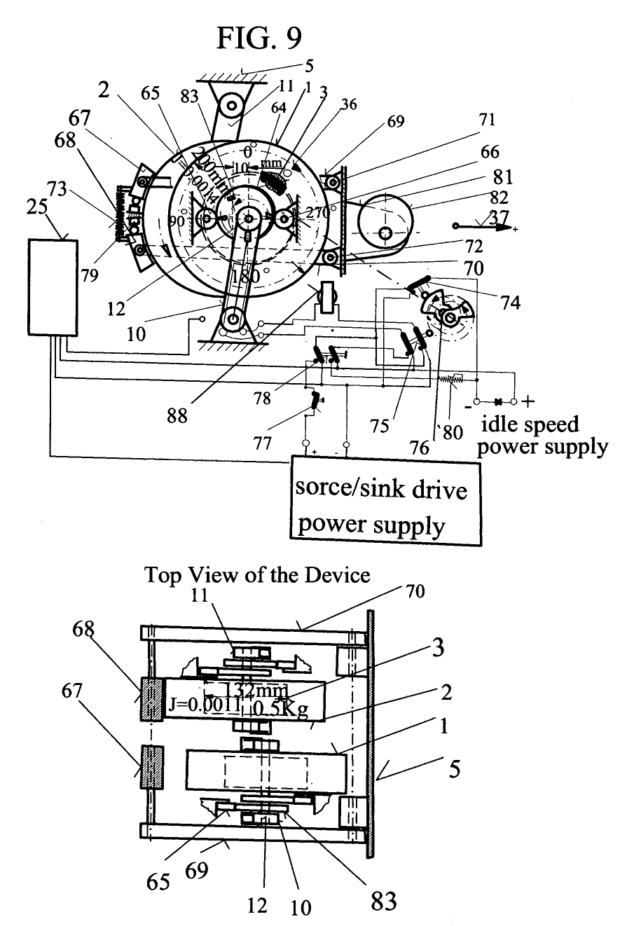

Referring now to FIG. 6 which depicts a graph of the motor-generator means alternating drive pulses for oscillatory motor-generator rotor rotation. The oscillatory rotation mode, delivers a more powerful propulsion force, because a maximum drive can be applied at the drive phase 90-180 arc degrees. The drive phase also reverses the rotation of the motor-generator rotor means, to start a new accumulation phase at 180 arc degrees, but in the reverse direction. The damping action is less effective in this mode.

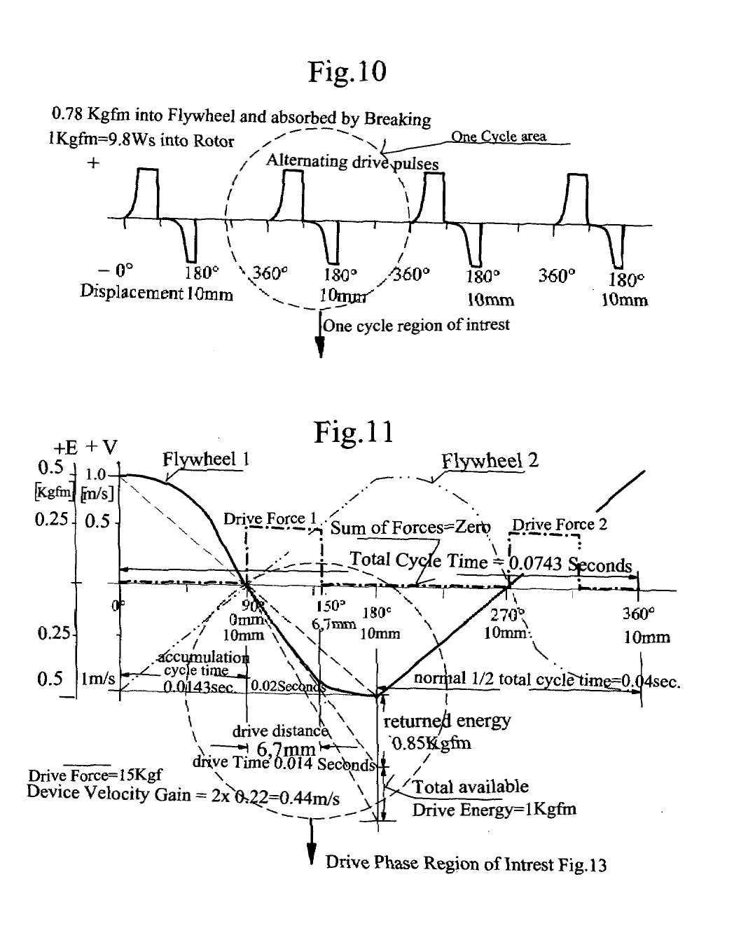

Referring now to FIG. 7, which depicts a graph of the typical resulting propulsion force generated by the pairs of flywheels 1 and 2. The propulsion force, starts to develop from the inertia elements during the drive phase, past 90 arc degrees; when the combined linear inertial reluctance of the flywheel assembly and the accumulated rotational kinetic energy of the motor-generator rotor, invest energy into the forward motion of the vehicle.

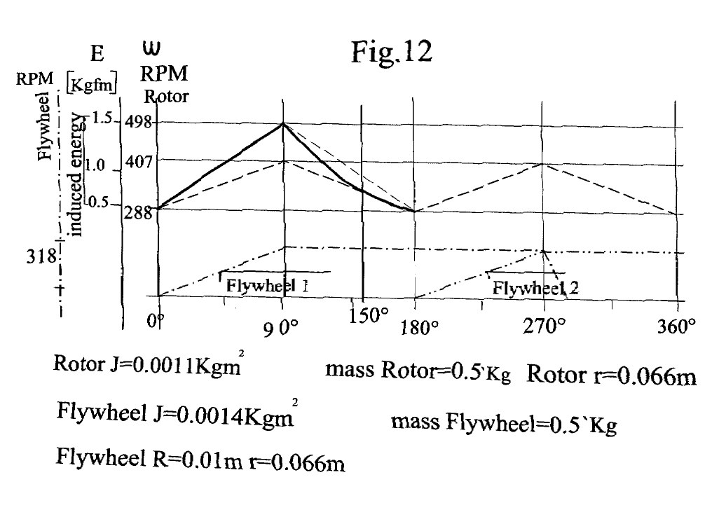

Referring now to FIG. 8, which depicts the vector parameters in correlation to the angular rotation of the motor-generator rotor 3. The directional arrow 50, indicates the angular acceleration of the flywheels. The directional arrow 36, indicates the continuous rotational direction of the flywheel 1, which is in a clockwise direction. The directional arrow 51, indicates the de-acceleration direction of the flywheel. The rotational direction 52, indicates the rotation of the motor generator means 3. The vector angle 53, between the position of the ex-centric member 14 and the right angle of the linear bearing 18, determines the instantaneous acceleration/de-acceleration characteristic of the linear flywheel inertia, following a sinusoidal motion. The centre line of mass moment of inertia is indicated with arrow circle 54. The vector triangle 56, is the instantaneous representation of the vector forces, for the indicated vector angle 53. The motor-generator 3 torque, acting against the reluctance of the flywheel 1 rotational inertia, generates the reciprocal tangential force vector couples 56 and 57. Force vector 58, is the main driving force for the inertial propulsion device during the drive phase 62. The tangential vector 57, generated between 20-90 arc degrees, is the main source of kinetic energy for the self-contained inertial propulsion device and is unimpeded. The kinetic energy is accumulated from 20-90 arc degrees in the motor generator rotors rotational inertia and is called the accumulation phase 61. The accumulated kinetic energy is then released during the drive phase 62, from 90-230 arc degrees. The accumulated kinetic energy is used to accelerate the linear inertia of the flywheel assemblies, in opposite direction of vehicular travel, thereby investing net linear kinetic energy into the vehicle in direction of vehicular travel, driving the vehicle forward. The excess rotational kinetic energy induced into the flywheels 1 and 2 during this reciprocal action is then absorbed by the imbedded electromechanical poles, between 180 and 270 arc degrees, preventing a loss of forward drive for the reversal of alternating motion. This method of self contained inertial propulsion depicted in FIG. 8, therefor becomes apparent, because the force vectors 59 and 60 are opposing, neutralising the main source moment of force tangential vector 57, for any reaction force opposite of vehicular travel direction; the force vector 57, is at the same time, inducing rotational kinetic energy into the motor-generator rotor means at an ever increasing rate, causing the kinetic energy accumulation phase 61. The reason that the main source moment of force is not acting as an opposing force to vehicular travel, is the increasing linear de-acceleration rate of the flywheel assemblies linear inertia, up to the reversal of flywheel assemblies linear sinusoidal movement at 90 arc degrees. The de-acceleration represented by force triangle 55, generates force vector 63, which generates force vector 60, which opposes force vector 59 and at the same time force triangle 55 increases up to the point of 90 arc degrees. This progressive increasing linear de-acceleration of the flywheel assembly's linear inertia during the accumulation phase, acts as a governing influence, returning any increase in linear kinetic energy instantaneously back into the rotational energy of the motor-generator rotor means, which represents a governing negative feedback loop and is also consistent and explained by the conservation of energy and the conservation of momentum and in final analysis by Newton third law of equal reaction action for an action. The action of angular acceleration of the motor-generator rotor and the induction or reduction of kinetic energy into and from the motor-generator rotor is by logic of the illustrated vectors therefore REACTION LESS. Furthermore, all directions of vectors will reverse during the reduction of kinetic energy in the motor-generator rotor, causing the same result of zero. The conclusion is therefore: The induction and reduction of motivating kinetic energy into the rotational momentum of the motor-generator rotor during the accumulation phase is reaction less in reference to the device, allowing for a self contained energetic linear impact by separation of the flywheel assembly, acting against the kinetic energy output to distribute linear kinetic energy into the propulsion device during the drive phase, in a ratio governed by the magnitude of the of moving masses. The distribution of energy during the drive phase is consistent with the conservation of energy, the conservation of momentum, the equality of impulse acting on the separating masses, the magnitude of potential energy of moving masses and most importantly is consistent with the equal reaction to an action BECAUSE the impact of separation is an equal reaction to an action. But most importantly, because of the before mentioned laws of physics, the drive phase distributes the available accumulated rotor kinetic energy according the distribution ratio to the flywheel assembly mass and to the device mass, which is the very principle of the combined effort inertial propulsion principle.

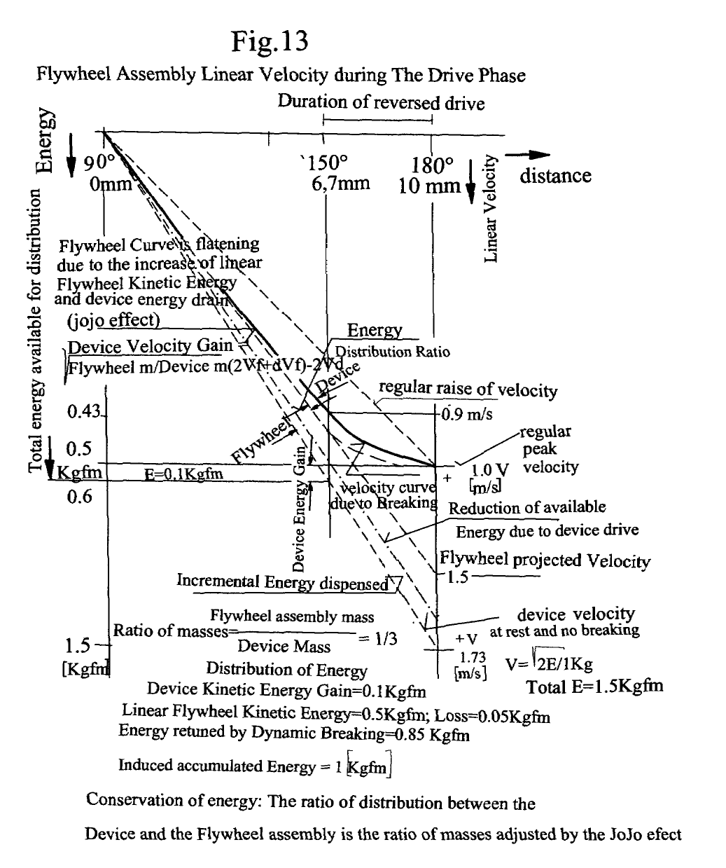

Referring now to FIG. 9, which depicts the propulsion device with a further possible rotational-to-reciprocating transmission means which includes a complementary cam 64 rigidly mounted on the central shaft 12 and opposing cam followers 65,66 mounted on the supporting frame 5. The cam followers represent the entrance point of the propulsion energy into the vehicle. The complimentary cam further includes the actuator means 83 for varying the slope of the cam. The flywheels 1, 2, the motor-generator means 3, the supporting frame 5, the swing-arms 10,11, central shaft 12 and directional vectors 36,37 are the same as in FIG. 1, FIG. 2, FIG. 3 and FIG. 4. The break-shoe means 67, 68 are used for absorbing excess rotational flywheel kinetic energy by contacting the flywheels 1 and 2 at approximately 265-285 arc degrees. The breaks-shoe means are mounted on swing-arms 69 and 70 which in turn are mounted on pivot points 71,72. The break-shoe means are forced against the flywheel 1 rim with spring 73. The break-shoe means can be of a variety of technology for example: Automotive type break-shoe material, electrical eddy-current technology or pneumatic type technology. The break-shoe actuator means 79 which varies the position of the break-shoe means for more or less demand for kinetic energy reduction in the flywheels 1,2 by varying effectively the duration of the break-shoe contact action. Oscillating rotation motion and gyration of the propulsion device is arrested with variable eccentric flywheel 82 and the rotational drive means 81. The rotational drive means can be of a variety of technologies including a synchronous motor. A further device for supplying timed power drive pulses to the motor-generator are cam-switch means 74 and 75 operated by cam 76 which is connected to the drive shaft 12. The cam switch means can be of several technologies including proxy-sensor-drivers. The device is switched on with switch 77. Idle power 21 and drive power is selected with switch 78. The rheostat 80 is for adjusting the drive power balance. The idle and drive power supply voltages are superimposed on the motor-generator with the method of connection, connecting cam-switch means 74,75 rheostat 80 and manual switch means 78. A electrical choke 88 is used for improving the shape of the electrical drive pulses for improved performance of the device. For illustrating the dimension of a typical combined effort inertial drive for the purpose of demonstrating the mathematical principle, dimensions are given for the flywheel D=200 mm, for the rotor d=136 mm, ½ kg mass for the flywheel and rotor respectively. The mass moment of inertia of the flywheel is 0.0036 Kgm̂2. The mass moment of the rotor is 0.0011 kgm̂2. The stroke of the cam is 0.01 meter. The ratio of one flywheel assembly in comparison to the second flywheel assembly plus the frame is one to three.

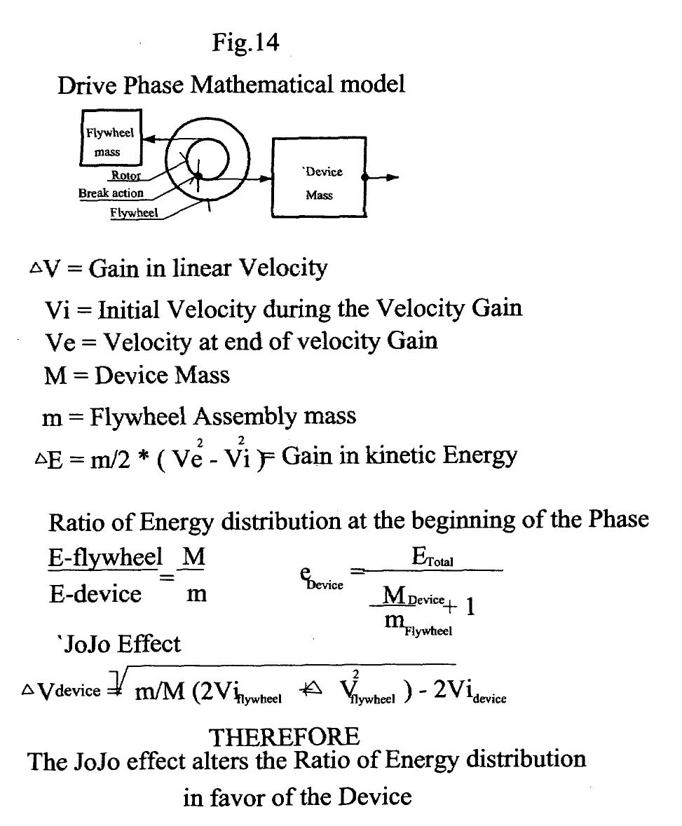

FIGS. 10,11,12 and 13 depicts and illustrates the timing method of inertial propulsion employing a complementary cam with opposing cam followers. FIG. 10 plots the input power for forward drive in relation to the rotation of the complimentary cam for one flywheel assembly. FIG. 11 plots the linear speed of the flywheel assembly 1 and 2 in comparison to the rotation of the complimentary cam, the flywheel assembly linear distance traversed and the resulting cycle time and thereby differential half cycle velocities. This differential of velocity is the source of propulsion power for the device. Because of the before mentioned velocity-differential of the devices mechanical motions from 0-180 to 180-360 arc degrees, a method of multiple integral flywheel motor-generator assemblies must work in a timed union to accomplish a vibration free seamless propulsion drive. FIG. 12 plots the motor generator rotor and flywheel velocities. FIG. 13 plots the drive phase velocity and energy dispensed in comparison to the linear and rotational distances traversed. The plot of the liner velocity of flywheel assembly, depicts most importantly, the reduction of dispensable energy delivered by the motor generator rotor, as it is delivered into the propulsion device. Thereby flattening the velocity curve of the flywheel assembly, allowing for the reaction less propulsion of the device. It becomes apparent from the analysis of the diagrams in FIG. 10 to FIG. 13 that the method of the inertial propulsion of the device is the progressive, reciprocal and alternately building and depletion of the kinetic energy levels in the linear and rotational flywheel assembly's masses superimposed with induction and deduction of fresh kinetic energy with the resultant progressive kinetic energy flow which in turn generates the progressive net force magnitudes for the propulsion of the device.

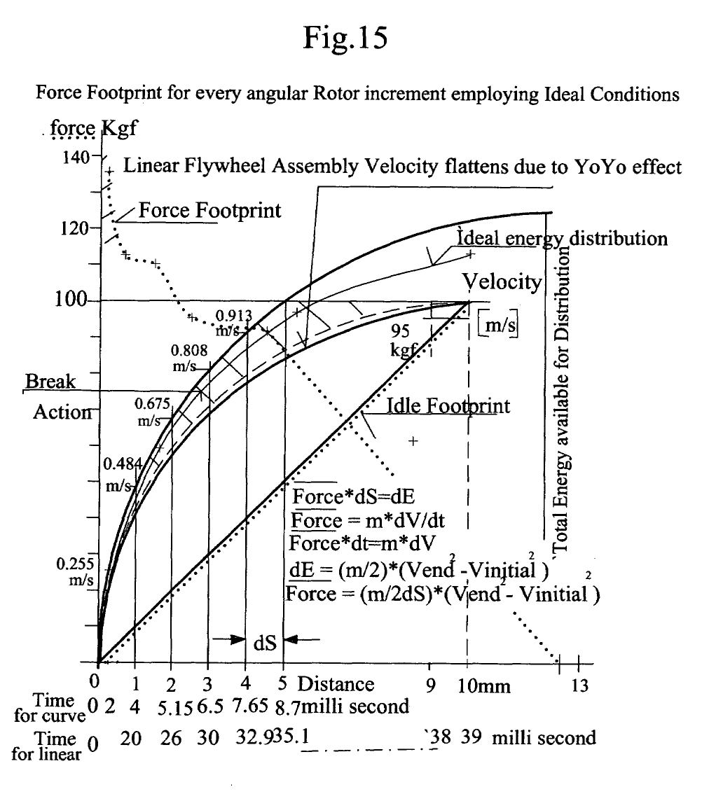

FIG. 14 depicts the mathematical model for the combined effort inertial propulsion drive phase. The ratio of energy distribution between flywheel and the device is the reversed ratio of the flywheel 1 mass to the (frame mass+flywheel 2 mass). Which is derived from the law of conservation of momentum, the law of conservation of energy and the law of potential kinetic energy of moving masses. Which is of central importance to the combined effort inertia drive and must be used for the design of the component dimensions and in final analysis presents the fact that a larger amount of kinetic energy accumulated in the motor-generator rotor, during the accumulation phase, is not necessarily providing a larger propulsion force. A further aspect of the mathematical model and the design consideration is the JoJo effect which comes in effect because of the rapid increase of the linear velocity of the flywheel assembly during the drive phase. The JoJo effect alters the ratio of energy distribution in favour to the device. The JoJo effect mathematical model is used to determine the real velocity gain for the device to be display on the display console.

FIG. 15 illustrate the ideal force footprint for every angular rotor increment during the drive phase. The intensity of kinetic energy flow for every rotor increment is very large at the beginning of the drive phase and zero at the end of the drive phase. The intensity of kinetic energy flow during the idle section of the propulsion cycle is low at the beginning and high ant the end of the idle cycle which is further important for the operation of the device. The ideal progression of the dispensation of the kinetic drive energy from motor-generator rotor is in an arc type progression, large acceleration at the start of the drive phase and the tapering off at the end of the drive phase. Thereby a maximum JoJo effect and a maximum reduction of motor-generator rotor rotational kinetic energy come into play for an improved energy distribution ratio.

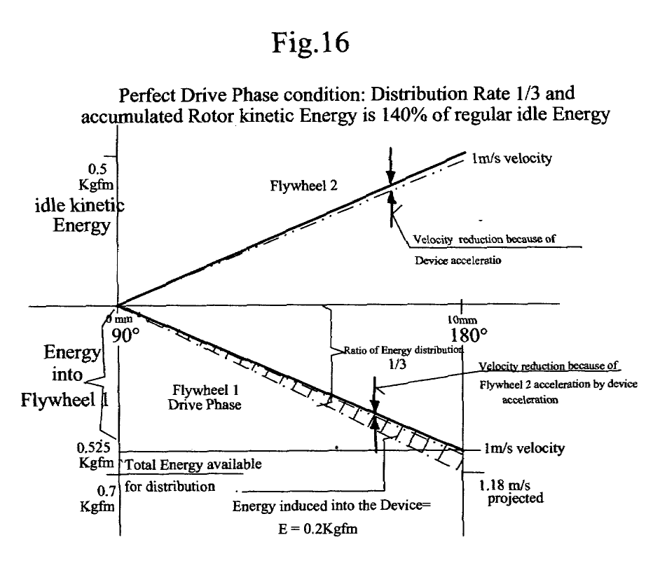

FIG. 16 is a combined effort inertial drive phase with perfect kinetic energy balance. For the design method of perfect drive phase design. The accumulated kinetic energy accumulated during the accumulation phase, in comparison to the regular idle cycle, kinetic energy must match the ratio of energy distribution for the drive phase. Therefore the flywheel assembly mass in operation divided by the (device frame+the mass of the idle flywheel assembly) must be the same ratio as the regular idle kinetic energy divided by the total accumulated energy during the accumulation phase.

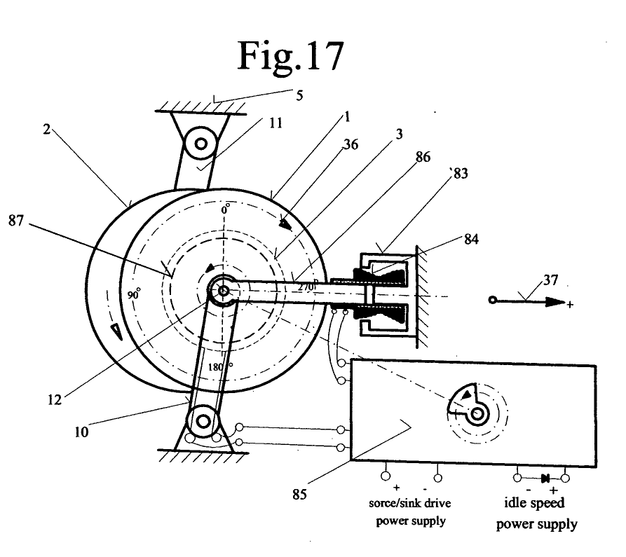

FIG. 17 is a combined effort inertia drive using a rotational-reciprocating transmission means with a voice coil/motor-generator combination. The voice coil 84 is engaging with the voice coil magnet 83 to motivate the flywheel assembly 1 in reciprocal strokes through the connecting rod 86. The additional motor-generator 87 is receiving kinetic energy pulses from the motor generator rotor 3 to generate electrical energy pulses to energise the voice coil. The command and control function 85 controls the voice coil power for timing and maximum performance.

While I have shown and described a preferred embodiment of my invention, if will be apparent to those skilled in the art that many changes and modifications may be made without departing from my invention in its broader aspect. I therefore, intend the appended claims to cover all such changes and modifications as fall within the true spirit and scope of my invention.

What is claimed is:

1. A device for self contained inertial vehicular propulsion in a predetermined direction comprising:
A supporting frame which is having freedom of vehicular directional travel and is used for the purpose of supporting the components of the device;
one or more pairs of linear guidance means, each containing a moveable member, mounted to the supporting frame with an orientation in the direction of vehicular travel and in close proximity to each other for providing pairs of carrier surfaces substantially moveable in opposing alternating reciprocal linear motion, and further, for neutralizing acceleration and de-acceleration forces by means of the paired opposing alternating motion;
a central shaft contained on each carrier surface of the moveable member by means of a first rotational bearing for giving the central shaft freedom of rotation in relation to the supporting frame;
a flywheel contained co-centrically on each central shaft by means of a second rotational bearing giving the flywheel free wheeling freedom of rotation in relation to the supporting frame and having opposing direction of rotation between one pair of flywheels for cancellation of rotational forces, and further, for providing an inertial backrest and a temporary rotational and linear kinetic energy storage capacity by means of the inherent inertial reluctance for the purpose of reaction less exertion of kinetic propulsion energy;
a motor-generator field means mounted co-centrically onto each flywheel for providing a force field;
a motor-generator rotor means mounted co-centrically on each central shaft for providing a rotational force field which is engaging with and operates within the motor-generator field means force field for generating rotational motions and torque with a preferable highest permissible angular velocity, and further having a temporary rotational kinetic energy storage capacity for the purpose of delivering a rotational impact momentum for the reaction less propulsion of the device; the motor-generator rotor means and the motor-generator field means are operating as
a motor-generator means for converting alternating energy pulses to alternating rotational kinetic energy pulses; the motor-generator means and the flywheel and the moveable member are operating as
an integral flywheel assembly for supplying and receiving alternating rotational kinetic energy drive pulses to and from the flywheels' free wheeling inertia and reciprocally into and from the motor-generator rotor means;
a rotational-to-reciprocating transmission means for converting the rotation and torque of the motor-generator rotor means into progressively changing reciprocal linear motion and linear forces, and further, for providing a progressively increasing linear de-accelerated motion in both directions of the reciprocal motion; the rotational-to-reciprocating transmission means further having
a rotational input/output means mounted co-centrically on each central shaft for receiving and delivering alternating rotational kinetic energy drive pulses from and to the motor-generator rotor means; the rotational-to-reciprocating transmission means further having
a linear reciprocating output/input means for delivering a reciprocal linear cyclic motion with a stroke length to the flywheel assembly where the preferred stoke length is smaller than the diameter of the motor-generator rotor means, and further, the cyclic motion having a time duration, where one complete cycle is containing two reversals of motions, two opposing linear strokes with equal peak linear velocities where the first stroke is in the direction of vehicular travel and the second stroke is in the opposite direction of vehicular travel, each stroke containing two half sections, each stroke contains an acceleration and a de-acceleration, each within a half section, with a differential magnitude and time duration, thereby giving each half section of each stroke a differential kinetic energy flow and a differential motivating force for the purpose of the propulsion of the device; the rotational-to-reciprocating transmission means further having
a kinetic energy output means mounted to the supporting frame and located centrally and opposite to the linear guidance means for coupling the linear reciprocating output/input means to the supporting frame and for delivering the propulsion energy into the supporting frame; the rotational-to-reciprocating transmission means further having
a negative feedback loop for providing a reciprocal differential feed path from the rotational input/output means to the linear reciprocation output/input means and for reciprocally feeding and reducing the rotational kinetic energy of the motor-generator rotor means into the linear kinetic energy of the flywheel assembly, and further, for feeding and depleting to zero the linear kinetic energy of the flywheel assembly into the rotational kinetic energy of the motor-generator rotor means for the purpose of delivering a linear to rotation coupled motion and for the reaction less exertion of kinetic propulsion energy;
a power-supply for supplying power to the motor-generator means;
a logic command control display console means containing the devices' optimum operational sequence thereby switching, timing, coordinating and optimizing the alternating energy drive pulses from and to the power supply to be used by the motor-generator means, the motor-generator means generates timed alternating kinetic energy drive pulses in response to the alternating energy drive pulses for the purpose of operating the device;
an encoder engaged with each central shaft to sense the position, the angular velocity and the timing information of the motor-generator rotor means for input into the logic control means which uses the encoder information to generate and optimize the timed alternating energy drive pulses;
a plurality of electromagnetic poles, imbedded in each flywheel side-wall, facing each flywheel in close proximity, for the purpose of absorbing the excess accumulated rotational kinetic energy from the flywheels in a reciprocal fashion and returning the energy back into the power-supply under the control of the logic control means;
the timed alternating kinetic energy drive pulses motivate the rotation of the motor-generator rotor means by reciprocally exerting against the flywheel mounted motor-generator field means and further against the free wheeling rotational inertial reluctance of the flywheel, thereby inducing additional rotational kinetic energy into the rotational inertia of the motor-generator rotor means, which is the source of the linear kinetic propulsion energy;
the positive half of the timed alternating kinetic energy drive pulses start past the half section of the stroke in direction of vehicular travel, and stops prior to the reversal of that motion;
the start of the timed positive kinetic energy drive pulse is the starting point of the inertial propulsion cycle and is the point of lowest rotational kinetic energy content of the motor generator rotor means;
the linear de-acceleration force caused by the progressive linear de-acceleration of the flywheel assembly, while moving from the starting point of the cycle to the momentary reversal of linear motion, is being converted by the rotational-to-reciprocating transmission means from a linear force into a rotational torque, this torque is causing the angular velocity of the motor generator rotor means to be accelerated at an equal measure;
the linear de-acceleration of the flywheel assembly is further exerting a force against the kinetic energy output means in direction of vehicular travel and at the same time the positive kinetic energy drive pulse causes a further linear acceleration force being exerted against the flywheel assembly and therefore causes an additional de-acceleration rate of the liner flywheel assembly and the additional de-acceleration rate causes an additional force in direction of vehicular travel;
the forced angular acceleration of the motor-generator rotor means is causing the linear kinetic energy content of the flywheel assembly being fed back into the motor-generator rotor means by the negative feedback loop, up until when the flywheel assembly comes to the reversal of linear motion when all linear kinetic energy of the flywheel assembly is exhausted, and furthermore also feeding back any new additional linear kinetic energy induced by the timed positive kinetic energy drive pulse into the flywheel assembly;
the rotational kinetic energy content of the motor-generator rotor means is at its' maximum level, compared within the cycle, at the end of the timed positive kinetic energy drive pulse;
the new additional kinetic energy is thereby instantaneously and concurrently absorbed by the flywheel assembly's additional linear acceleration, caused by the timed positive kinetic energy drive pulse, because the additional acceleration and accompanying force in opposite direction of vehicular travel causes an instantaneously equal measure of de-acceleration and additional force in direction of vehicular travel causing both effective average forces to cancel to a sum of zero, thereby complying with the principle of an equal reaction to an action;
the timed positive kinetic energy drive pulse is thereby not exerting a force into the kinetic energy output means in opposite direction of vehicular travel because the additional induced linear acceleration force is absorbed by the additional measure of the negative feedback loop, and further, the acceleration force is exerted reciprocally against the reluctance of the flywheels' free wheeling rotational inertia;
the timed positive kinetic energy drive pulse has a preferred rising slope characteristic, progressing from zero to the maximum, where the maximum coincides with the reversal of linear motion of the flywheel assembly, therefore complying with the progressive nature of the rotational-to-reciprocating transmission means and the characteristic of the negative feedback loop and thereby maximizing the effective drive performance;
the timed positive kinetic energy drive pulse thereby accumulates additional kinetic energy into the rotational inertia of the motor-generator rotor means without impediment against the supporting frame, which is then used for the propulsion of the device;
the progressive linear de-acceleration characteristic of the rotational-to-reciprocating transmission means causes the gain in angular velocity of the motor-generator rotor means, during the application of the timed positive kinetic energy drive pulse, to progress at an exponential rate, thereby causing the linear velocity of the flywheel assembly to diminish, at the end of the stroke, in an exponentially steep slope, this steep slope is continuing past the reversal of motions into the opposite direction of vehicular travel as a steep gain in linear velocity, the steep gain in linear velocity of the flywheel assembly measured over a fraction of the stroke is delivering an exponentially higher kinetic energy flow into the kinetic energy output means, for that fraction, because the kinetic energy delivered for that fraction is the gain in velocity squared and then divided by two;
the additional kinetic energy accumulated in the motor-generator rotor means, at the end of the timed positive kinetic energy drive pulse, is being used to accelerate the linear inertia of the flywheel assembly in opposite direction of vehicular travel, at the additional rate exceeding the average effective rate within the cycle, by exerting reciprocally against the kinetic energy output means, thereby inducing net linear kinetic energy into the kinetic energy output means and further into the supporting frame of the device in accordance to the distribution ratio governed by the ratio of the device mass to the flywheel mass, therefore driving the device in direction of vehicular travel, and further, blending the large rotational momentum of the motor-generator rotor means with the linear momentum of the device, thereby accomplishing a proportional gain in momentum for the device, and further, the driving of the device is therefore an impact by separation by blending the additional rotational momentum of the motor-generator rotor means with the linear momentum of the device and with the linear momentum of the flywheel assembly, thereby reducing the angular velocity of the motor-generator rotor means accordingly and providing an increased acceleration rate and reduced time duration for the half stroke length during the driving of the device;
the progressive characteristic of the rotational-to-reciprocation transmission means causes the initial linear acceleration of the flywheel assembly, during the driving of the device, to be large and then to progress in a progressively diminishing manner to zero, thereby causing a large initial intensity of separation impact, and further causing a larger portion of kinetic drive energy to be induced into the device during the first half of the driving of the device, because the kinetic energy delivered over a fraction of the stroke is the squared gain in velocity, during that fraction, divided by two, therefore the larger acceleration is contribution an exponentially larger kinetic energy quantity;
the rotational kinetic energy of the motor-generator rotor means, at the midpoint-travel during the stroke in opposite direction of vehicular travel, is therefore reduced by the kinetic energy induced into the kinetic energy output means, and further, the rate of linear flywheel assembly acceleration, during the driving of the device, is at the maximum level for comparison within the cycle, causing a maximum acceleration force to be exerted;
the negative part of the alternating kinetic energy drive pulses has a preferred drive timing coinciding with the approaching depletion of the additional rotational kinetic energy of the motor-generator rotor means and has the logical opposite operation to the positive kinetic energy drive pulse with reversed direction of linear forces and torque, thereby removing excess unused rotational kinetic energy from the motor-generator rotor means without impediment against the supporting frame due to the negative feedback loop, because a reduction in motor-generator rotor means angular velocity causes a reduction in effective de-acceleration forces in opposite direction of vehicular travel, and further causing a subsequent progressive reduction in acceleration forces in direction of vehicular travel, the induction and reduction of rotational kinetic energy into and from the motor-generator rotor means is thereby reaction less;
the acceleration in opposite direction of vehicular travel, with above effective average intensity, in comparison to the at effective average de-acceleration and subsequent acceleration in direction of vehicular travel, thereby causes an elastic impact intensity differential in favour of the direction of vehicular travel;
the timed negative kinetic energy drive pulse has a relative lower intensity and later start timing than the positive energy drive pulse with an effective average intensity and duration to sufficiently feed the excess unused rotational kinetic energy of the motor-generator rotor back means into the flywheel and back into the power-supply via the path of the negative feedback loop, and further, the negative kinetic energy drive pulse is timed for reducing the gain in linear acceleration of the flywheel assembly, during the driving of the device, to level off at the peak linear velocity of the cycle while maintaining a positive minimum level of linear acceleration, thereby, the operation is locking in the gain in momentum of the device and is complying with the principle of conservation of momentum, and further, the differential between the positive kinetic drive pulse effective energy content subtracted from the effective energy content of the negative kinetic drive pulse is thereby the total kinetic energy invested into the inertia of the device because of the principle of conservation of kinetic energy;
due to the increased effective average linear acceleration rate of the flywheel assembly and the accompanying larger than average effective applied acceleration force and a shorter than average time duration for the half stroke length during the driving of the device, causes a larger than effective average amount of kinetic energy to be released into the kinetic energy output means, because;
the total amount of kinetic energy released, within the half stroke length during the driving the device, is the magnitude of the average effective acceleration force, exerted over the half stroke length, multiplied by the half stroke length, and further, the average effective acceleration force over the half stroke length during the driving of the device, is the sum of all the squared momentary velocity gains divided by two length of the associated instantaneous stroke fraction, therefore an initial large acceleration gain followed by a levelling off at the end of the driving of the device is delivering a higher propulsion energy than an lower initial acceleration gain, and therefore further, the efficient transfer of kinetic energy from the motor-generator rotor means into the kinetic energy output means increases progressively with the a further increased angular velocity of the motor-generator rotor means;
in case the device is forcibly held at rest and the positive kinetic drive pulse remains at the same level, then most of the new linear kinetic energy induced is returned to the power supply by the increased intensity of the negative kinetic energy drive pulse, thereby the device is exerting the maximum drive force and is complying with the principle of conservation of energy;
in case the timed negative kinetic energy drive pulse is absent, the rotational inertia of the motor-generator rotor means will accumulate the induced rotational kinetic energy and increase its' angular velocity accordingly;
the total kinetic energy, induced into to motor-generator rotor means by the timed positive kinetic energy drive pulse, is therefore diverted according to the relative resistance to the propulsion of the device, the lower the resistance and the higher the rate of drive accelerations the more propulsion energy is absorbed by the device;
the excess rotational kinetic energy, accumulated during the reaction-less propulsion in the rotational inertia of each flywheel, is absorbed by the imbedded electromagnetic poles reciprocally between each flywheel of the pair, the logic control means preferably activates the electromagnetic poles at intervals when the alternating kinetic energy drive pulses are inactive, thereby returning the excess rotational kinetic energy to the power-supply without impeding against the supporting frame;
therefore concluding in summary, the self-contained inertial vehicular propulsion of the device is realised because the exertion of forces is against the reluctance of free wheeling inertia of the flywheel, excess rotational flywheel kinetic energy is absorbed reciprocally and the negative feed back loop is cancelling acceleration and de-acceleration forces in opposite direction of vehicular travel to a sum of zero allowing a directional differential of linear forces and kinetic energy, which is caused by the differential in the rate of accelerations, thereby causing the sum of elastic impacts durations and intensities in direction of vehicular travel to exceed the sum of elastic impacts durations and intensities in opposite direction of vehicular travel.

2. A device as claimed in claim 1, employing the method of inertial vehicular propulsion comprising the steps of:
the motor-generator rotor means having a counter-clockwise rotation being divided into 360 arc degrees for analysis purposes;
the point zero arc degree is at the mid point travel of the flywheel assembly's reciprocating motion toward the devices' direction of travel;
the direction of travel is the line-direction extending from the 90 arc degree to the 270 arc degree position;
the method steps describe the operation of one flywheel assembly of the pairs of flywheels, the operation of the second flywheel assembly is simply the opposite movement of the first for the purpose of negating rotational and vibratory forces to a sum of zero;
the logic control means, by receiving timing information input from the encoder, directs energy pulses from the power-supply to the motor-generator means, thereby energizing the motor-generator means to supply timed alternating rotational kinetic energy drive pulses;
the rotational kinetic energy drive pulses acting against the reluctance of the flywheels' free wheeling rotational inertia are exerting reciprocal rotational kinetic energy drive pulses into the motor-generator rotor means thereby resulting in torque pulses to be generated;
the resultant reciprocal torque pulses in the motor-generator rotor means are unimpeded in relation to the supporting frame because the flywheels' rotational inertia has freedom of rotation in relation to the supporting frame;
the motor-generator rotor means resultant torque pulses have a positive and a negative direction depending on the direction of the energizing energy drive pulse;
the positive resultant torque pulse is motivating the motor-generator rotor in an increasing counter clockwise rotation, thereby motivating the flywheel assembly in an increasing linear motion by means of the rotational-to-reciprocating transmission means and by exerting against the kinetic energy output means;
the progressively changing reciprocal linear motion of the flywheel assembly's linear inertia is following a sinusoidal motion and is thereby generating corresponding instantaneous linear acceleration and de-acceleration forces against the kinetic energy output means, larger acceleration creates larger instantaneous forces;
the flywheel assembly, without newly induced kinetic energy, thereby obtains a peak linear velocity at 0 and 180 arc degrees and obtains an instantaneous standstill at 90 and 270 arc degrees, thereby, the flywheel assembly obtains a maximum linear kinetic energy content at 0 and 180 arc degrees and obtains a zero linear kinetic energy content at 90 and 270 arc degrees, therefore the motor-generator rotor means also attains maximum rotational velocity at 90 and 270 arc degrees and minimum rotational velocity at 0 and 180 arc degrees with corresponding maximum rotational kinetic energy content at 90 and 270 arc degrees and minimum rotational kinetic energy content at 0 and 180 arc degrees, and further, without any new induction of kinetic energy, considering subsequent motions, the sum of forces exerted against the pair of kinetic energy output means by the pair of flywheel assembly's is zero because this linear to rotation coupled motion works with the principle of conservation of kinetic energy;
the positive rotational kinetic energy drive pulses supplied from the motor-generator rotor means is timed from 20-90 arc degrees which drives and accelerates the motor-generator rotor means in counter-clockwise rotation, thereby accumulating rotational kinetic energy in the motor-generator rotor means, which is the source of propulsion energy;
the positive rotational kinetic energy drive pulse accelerates the linear inertia of the flywheel assembly in the direction of vehicular travel by means of the rotational-to-reciprocating transmission means and exerting reciprocally against the kinetic energy output means;
due to the sinusoidal de-acceleration of the linear flywheel assembly inertia during the positive kinetic energy drive pulse occurring from 20 to 90 arc degree, the additional linear kinetic energy induced into the flywheel assembly is instantaneously fed back into the motor-generator rotor means rotational inertia by the negative feedback loop;
because the instantaneous linear acceleration force caused by the positive kinetic energy drive pulse is opposing the concurrent resulting instantaneous linear de-acceleration force, therefore causing both forces to cancel to a sum of zero, and further, thereby complying with the principle of equal reaction to an action;
the positive kinetic energy drive pulse thereby generates no opposing force to the propulsion of the device because of the free wheeling rotational inertial reluctance of flywheel and the negative feedback loop characteristic of the rotational-to-reciprocating transmission means, while accumulating rotational kinetic energy into the motor generator rotor means resulting in an increased angular velocity at 90 arc degrees of the motor-generator rotor means;
the positive kinetic energy drive pulse has a preferred progressive rising lope characteristic progressing from zero to the maximum, which coincides with the end of the positive kinetic drive pulse and which complies with the progressive linear de-acceleration and the characteristic of the feedback loop for maximum drive efficiency;
the increased angular velocity of the motor-generator rotor means at 90 arc degrees accelerates the linear flywheel assembly's inertia from the instantaneous standstill in opposite direction of vehicular travel at a rate exceeding the effective average of the reciprocal motion;
the increased linear acceleration rate from 90 arc degrees to 180 arc degrees, compared to the acceleration rate present from 270 to 0 arc degrees, is exerting an increased acceleration force over the stroke length and therefore causing a net increase in kinetic energy delivered reciprocally into the kinetic energy output means in direction of vehicular travel, thereby the inertia of the device responds to the force with an acceleration in direction of vehicular travel;
the logic control means energizes the motor-generator means with a negative power pulse from approximately 120 arc degrees to 200 arc degrees which results in a timed negative rotational kinetic energy drive pulse being generated in the motor-generator rotor means;
the timed negative kinetic energy drive pulse has a logical operation opposite to the positive kinetic energy drive pulse for the purpose of absorbing the rotational kinetic energy from the motor-generator rotor means, thereby reducing the angular velocity of the motor-generator rotor means and the angular velocity of the flywheel and returning the energy to the power supply;
the timed negative kinetic energy drive pulse has a measured intensity to allow rotational kinetic energy to remain in the motor-generator rotor means to maintain a sufficient continuing angular velocity and at the same time allow the rate of acceleration and linear velocity of the flywheel assembly to level off at the peak linear velocity of the cycle at 180 arc degrees, thereby locking the kinetic energy induced into the kinetic energy output means without causing a additional force in opposite direction of vehicular travel;
in case the device is forcibly held at rest and the positive kinetic energy drive pulse remains constant then most of the linear and rotational kinetic energy will be absorbed by the increased intensity of the negative kinetic energy drive pulse and retuned to the power-supply, thereby the device is exerting the maximum drive force and is complying with the principle of conservation of kinetic energy;
the logic control means energizes the electromechanical poles preferable at intervals when the alternating kinetic energy drive pulses are inactive thereby absorbing the excess rotational kinetic energy accumulated in the flywheels and return the energy back to the power supply.

3. A device as claimed in claim 1, in which the rotational-to-reciprocating transmission means comprises:
an ex-centric member having a length, of which one end is mounted on the central shaft, which represents the rotational input/output means; the rotational-to-reciprocating transmission means further comprises
a wrist-pin, which is mounted on the opposite end of the ex-centric member and represents the linear reciprocating output/input means; and the rotational-to reciprocating transmission means further comprises
a linear bearing which contains the wrist pin and represents the kinetic energy output means and which is mounted on the supporting frame perpendicular to the flywheel axis and central to the linear guidance means.

4. A device as claimed in claim 1 further comprising:
a power-commutator means, mounted on each central shaft, for timing the motor-generator means alternating energy drive pulses.

5. A device as claimed in claim 1, in which the rotational-to-reciprocating transmission means further comprises:
a damping means; and
a connecting rod;
where the connecting rod connects the kinetic energy output means to the damping means, moderating the vibrations and guiding the flywheel motor-generator means according the logic control means.

6. A device as claimed in claim 5, in which the damping means comprises an electromechanical damping means with the ability to restore power to the power-supply.

7. A device as claimed in claim 1, in which the kinetic energy output means further includes:
a pressure sensor for sensing the instantaneous forward propulsion force for input into the logic control means.

8. A device as claimed in claim 1, in which the movable member of the guidance means further comprises an encoder for the sensing of the position and rotational speed of the flywheel, for input into the logic control means for the timing and maximizing the alternating kinetic energy pulses.

9. A device as claimed in claim 1, in which the logic control means further comprises
a command and control input for speed and directional control of the vehicle, for varying the timing and the power levels of the kinetic energy drive pulses to the pairs of motor-generator rotor means in a differential fashion.

10. A device as claimed in claim 1, in which each guidance means comprises:
a pivot; and the movable member comprises
a swing arm
where the socket end of the swing-arm is contained on the supporting frame by the pivot and the wrist-end of the swing-arm is containing the central shaft.

11. A device as claimed in claim 10, further comprising:
a differential transmission mounted centrally on each central shaft and engaging with the flywheel thereby forming an integral flywheel differential-transmission assembly for delivering kinetic energy reciprocally to both the flywheel and the rotational input/output means;
a rotational transmission means mounted centrally on each socket-end of the swing-arms for transmitting rotational energy to the flywheel assemblies;
a timing clutch and buffer means, connected to the rotational transmissions means, for delivering timed kinetic energy drive pulses to each flywheel assembly according to the logic control means;
a continuous running motor for supplying rotational kinetic energy to the timing clutch and buffer means.

12. A device as claimed in claim 11, wherein the rotational transmission means comprises a chain drive.

13. a device as claimed in claim 11, wherein the rotational transmission means comprises a shaft and gear drive.

14. A device as claimed in claim 11, in which the differential transmission means comprises a differential fluid drive.

15. A device as claimed in claim 3, in which the length of the ex-centric member is slide-able variable to make the reciprocal motion of the flywheel assembly variable.

16. A device as claimed in claim 1, in which the kinetic energy output means comprises:
a timing motor mounted onto the supporting frame perpendicular to the flywheel assembly axis and central to the guidance means;
a motor shaft contained in the timing motor;
a timing wheel means, which is mounted on the motor shaft and is engaging with the reciprocating output/input means for the purpose of timing and assisting the reciprocating movements of the flywheel assemblies according to the logic control means.

17. A device as claimed in claim 16, in which the timing motor is further having
a power commutator mounted on the motor shaft, for the purpose of timing the motor-generator means kinetic energy drive pulses.

18. A device as claimed in claim 1, in which the motor-generator means comprises an electrical motor-generator.

19. A device as claimed in claim 1, in which the motor-generator means comprises a fluid-motor-pump.

20. A device as claimed in claim 16, in which the timing wheel means comprises
a timing crank.

21. A device as claimed in claim 1, in which the guidance means comprises
a linear bearing.

22. A device as claimed as in claim 1, in which the guidance means comprises
a linear slide.

23. A device as claimed in claim 1, in which the rotational-to-reciprocating transmission means comprises:
a complimentary cam mounted on each central shaft for the purpose of the rotational/reciprocating input/output means;
two cam followers mounted mutually opposing on the supporting frame for the purpose of Following the contour motions of the complimentary cam acting as the kinetic energy output means for transmitting the propulsion energy into the supporting frame;
an actuator means for varying the slope of the complementary cam.

24. A device as claimed in claim 23, in which the supporting frame further comprises
a plurality of cam-switch means for the purpose of supplying timed energy drive pulses to the motor-generators means;
a plurality of cams rotationally connected to the central shaft for the purpose of operating the cam-switch means;
a plurality of manual switch means for the purpose of operating the device in disconnect, idle and full power mode;
a power supply for operating the device in idle power;
a plurality of break-shoe means for the purpose of absorbing excess rotational kinetic energy from the flywheel assemblies;
a plurality of break-shoe actuators means for the purpose of adjusting the timing of the break-shoes;
one or more flywheels mounted ex-centrically on a rotational drive means for arresting oscillating rotational motion or gyrations of the device;
one or more rheostats for adjusting the drive power balance.

25. A device as claimed in claim 24, where the method of electrical wiring, connecting the
cam-switch means;
the manual switch means and;
the rheostats comprises the steps of superimposing the alternating energy drive pulses with the idle power supply voltage for high speed rotation of the motor-generator rotor means.

26. A device as claimed in claim 24 where the cam-switch means further comprises cam operated proxy-sensor-drivers.

27. A device as claimed in claim 24 where the break-shoe means are comprising automotive type break-shoes.

28. A device as claimed in claim 24 where the break-shoe means are comprising electrical eddy-current technologies.

29. A method as claimed in claim 2 comprising the method steps of
analysing and
computing the gain of kinetic energy and gain of velocity induced into the device for the purpose of display on the display console and for the purpose of design analysis by using the step of
computing the total kinetic energy accumulated into the motor-generator rotor means during 20-90 arc degrees of the flywheel cycle and
plot the progression of the power distribution to the device and to the flywheel assembly in comparison to the flywheel assembly linear stroke, by
using the power distribution ratio as the ratio of the flywheel assembly mass compared to the sum of the supporting frame mass plus the flywheel assembly mass.

30. A method as claimed in claim 2 comprising the method steps of
varying the timing of the timed alternating drive pulses under control of the command and control function, thereby causing an imbalance in the rotational momentum of the device to accomplish a steering action of the device

31. A device as claimed in claim 1 further comprising:
a voice-coil with progressively increasing coil density and
a voice coil magnet mounted on the supporting, frame, acting as the kinetic energy output means;
a connecting rod having two ends, the first end is connected to the central shaft and the second end is mounting the voice-coil;
a additional electrical motor-generator mounted firmly on the guidance means and central to the central shaft for receiving and supplying kinetic energy pulses from the motor-generator rotor means and energizing the voice coil magnets to linearly motivate the flywheel assembly in reciprocal strokes
a logic control and drive function for applying timed drive pulses and idle power to the motor-generator and the voice-coil in a coordinate timing sequence and magnitude to accomplish a maximum propulsion energy.
